(19) United States
(12) Patent Application Publication
(10) Pub. No.: US 2011/0153490 A1
(43) Pub. Date: Jun. 23, 2011

(54) Methods, Systems, and Products for Providing Good Faith Estimates

(76) Inventor: Thomas M. Martignoni, Raleigh, NC (US)

(21) Appl. No.: 12/644,816

(22) Filed: Dec. 22, 2009

(51) Int. Cl. G06Q 40/00

(52) U.S. Cl. 705/38

(57) ABSTRACT

Methods, systems, and products are disclosed for providing good faith estimates. When a good faith estimate for a mortgage application is selected for printing, a prompt is made to determine whether the good faith estimate will be provided to a prospective borrower. If the good faith estimate will be provided to the prospective borrower, then the good faith estimate is generated, printed, and an electronic copy is stored in memory. When, however, the good faith estimate will not be provided to the prospective borrower, then the electronic copy of the good faith estimate is modified with a conspicuous notice that the good faith estimate is not for disclosure to the prospective borrower.

### CROSS-REFERENCE TO RELATED APPLICATIONS

This application claims the benefit of U.S. Provisional Application 61/254,913, filed Oct. 26, 2009, entitled “GFE Tracker,” and incorporated herein by reference in its entirety.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The present invention relates to tracking good faith estimate disclosures in the mortgage industry.

Disclosures are important in mortgage loans. When a lender's loan officer takes a mortgage application from an applicant, or when information is received that sufficiently constitutes a mortgage application, then certain disclosures have to be provided to the prospective borrower. Particularly, lenders must disclose fees at different stages of the process. If circumstances change, lenders may need to take certain actions, such as providing an updated disclosure to the borrower. Lenders may also be required to cure closing costs that are not consistent with previously provided disclosures.

The disclosure requirements create challenges for lenders. Lenders, for example, may want to track and compare disclosed fees to current fees. Lenders may also want to track the fees that are actually charged to a borrower. Unfortunately, though, lenders do not have systems in place that store and track what information is disclosed to the prospective borrower. Indeed, lenders do not know what information has been disclosed by the loan officer. Loan officers and mortgage brokers may fail to reveal (whether intentionally or unintentionally) what fees have been disclosed to the prospective borrower. Even if disclosure is complete, the printed documents or photocopies that disclose fees may not be available to perform a comparison.

### DESCRIPTION OF THE DRAWINGS

The features, aspects, and advantages of the exemplary embodiments are better understood when the following Detailed Description is read with reference to the accompanying drawings, wherein:

FIG. 1 is a schematic illustrating an operating environment, according to exemplary embodiments;

FIG. 2 is a schematic illustrating an electronic copy of a good faith estimate, according to exemplary embodiments;

FIGS. 3-5 illustrate a method of providing good faith estimates, according to exemplary embodiments;

FIGS. 6-7 are flowcharts further illustrating the method of providing good faith estimates, according to exemplary embodiments; and

FIG. 8 is a more detailed schematic illustrating the operating environment, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. The reader will further understand that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. The reader will further understand that when an element is referred to as being “connected” or “coupled” to another element, the element may be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The reader will further understand that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

Within this document the following definitions are used.
Fees: Fees are a set of different charges that as a total are the cost of closing a loan.
Disclosed Fees: Disclosed Fees are the Fees that a prospective borrower is being informed that he or she will be charged when closing a loan.
Fees at Closing: Fees at Closing are the Fees that a prospective borrower is charged when closing a loan.
Current Fees: Current Fees are the Fees that are current in the loan origination software. They would become the Fees at Closing if the closing of the loan happened with these fees.
Not Disclosed Fees: Not Disclosed Fees are Fees that have never been communicated to the prospective borrower.
Good Faith Estimate: A document that is being printed, emailed or made available in electronic form. This disclosure considers documents that serve the purpose of informing a prospective borrower of the Fees to be a Good Faith Estimate. Once a Good Faith Estimate with Fees has been made available to a prospective borrower, such Fees as provided to the borrower become Disclosed Fees.
Printing: Printing encompasses printing on paper or another physical media as well as creating an electronic document that can be opened and read with devices used to access such documents.

Exemplary embodiments provide methods, systems, and products that track the history of fees communicated to the prospective borrower. Exemplary embodiments may also validate if the fees at closing are allowable based on a set of rules applied to the history of the disclosed fees and the current Fees. Exemplary embodiments thus distinguish between Disclosed Fees and Not Disclosed Fees. These fees may be tracked as numbers, and any printed documents may be stored directly in a printable format.

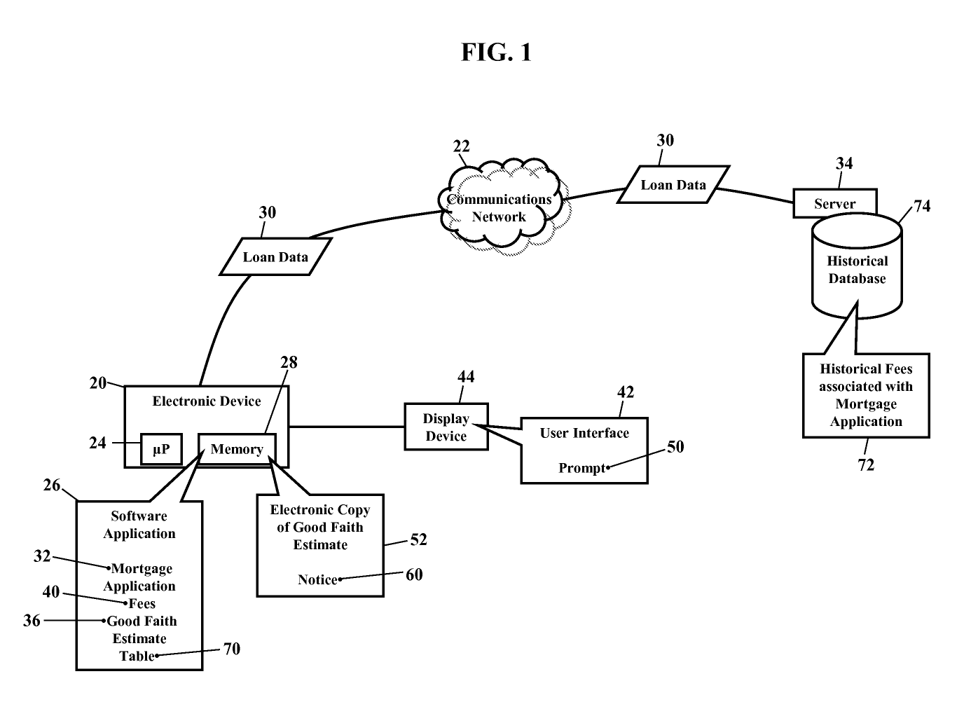

FIG. 1 is a schematic illustrating an operating environment, according to exemplary embodiments. While exemplary embodiments may be applied to any manual or paper environment, here exemplary embodiments are applied to a network environment. A processor-controlled device 20 communicates with a communications network 22. The processor-controlled device 20 comprises a processor 24 (e.g., “μP”), application specific integrated circuit (ASIC) or a network of computers or processors, or other similar device that executes a software application 26 stored in memory 28. Although the processor-controlled device 20 is generically shown, the processor-controlled device 20, as will be later explained, may be a computer, server, or any other device. Whatever the processor-controlled device 20, the processor-controlled device 20 may receive loan data 30. The loan data 30 describes a mortgage application 32 requested by a prospective borrower. The loan data 30 is illustrated as being remotely retrieved from a server 34, but the loan data 30 may additionally or alternative be locally retrieved from the memory 28. The software application 26 may comprise processor-executable instructions that retrieve the loan data 30 and that generate a good faith estimate 36.

The good faith estimate 36 discloses fees 40 associated with the mortgage application 32. Loan officers generally print multiple draft versions of the good faith estimate 36, with each draft having different financial scenarios. The loan officer typically makes adjustments to the fees, and prints several versions of the good faith estimate 36, before selecting an optimal solution. When the loan officer selects the optimal loan solution, the loan officer prints a final version of the good faith estimate 36. The loan officer then provides the final version to the prospective borrower. For legal purposes and tracking values, though, only the final version of the good faith estimate 36 is of interest. The draft versions may have internal relevance to the lender, but the draft versions have little or no legal implication. For regulatory purposes, then, the lender is only interested in the good faith estimate 36 that is provided to the prospective borrower. The lender is not required to track draft versions of the good faith estimate 36.

Exemplary embodiments may thus prompt if the good faith estimate 36 will be provided to the prospective borrower. As FIG. 1 illustrates, the software application 26 may cause the processor 24 to produce a user interface 42. The user interface 42 is illustrated as being graphically presented or displayed on a display device 44, but the user interface 42 may have audile features. A loan officer, broker, or other user of the software application 26 typically selects an icon or inputs a command to print the good faith estimate 36. When the software application 26 receives the user's selection, the user interface 42 produces a visual and/or audible prompt 50. The user interface 42 prompts the user whether the good faith estimate 36 will be provided to a prospective borrower. If the good faith estimate 36 will be disclosed to the prospective borrower, then the software application 26 generates the good faith estimate 36 and stores an electronic copy 52 of the good faith estimate 36 in the memory 28.

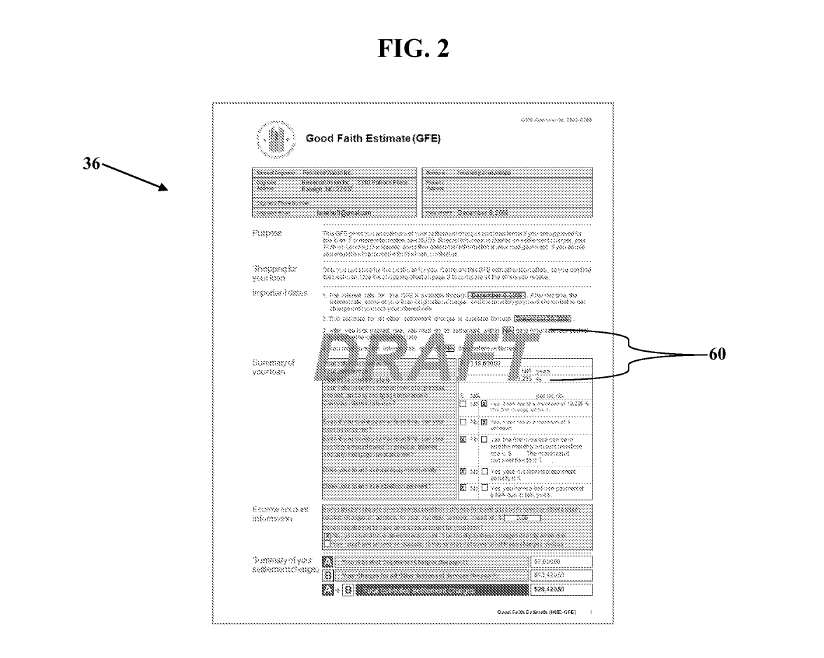

FIG. 2 is a schematic illustrating the electronic copy 52 of the good faith estimate 36, according to exemplary embodiments. Here, however, the good faith estimate 36 includes a conspicuous notice 60. When the user indicates that the good faith estimate 36 will not be provided to the prospective borrower, then the software application 26 modifies the electronic copy 52 of the good faith estimate 36. The software application 26, for example, adds the conspicuous notice 60 to the electronic copy 52. The conspicuous notice 60 indicates that the good faith estimate 36 is not for disclosure to the prospective borrower. The conspicuous notice 60 may include emphasized or highlighted text or symbols, an electronic watermark, overlays, or any other visual and/or audible indicators that the good faith estimate 36 is not for disclosure to the prospective borrower. However the conspicuous notice 60 is added, the software application 26 then stores the modified electronic copy 52 of the good faith estimate 36 in the memory 28.

Exemplary embodiments thus help lenders satisfy regulatory disclosure requirements. Exemplary embodiments help the loan officer decide if the good faith estimate 36 has been handed to the prospective borrower. The software application 26 prompts the user (e.g., the loan officer or broker), prior to printing, whether the good faith estimate 36 will be handed over to, or disclosed to, the prospective borrower. If the loan officer decides not to hand the good faith estimate 36 to the prospective borrower, then the good faith estimate 36 will be conspicuously marked in a way that it cannot or should not be provided to the prospective borrower. The software application 26, for example, may apply a watermark and/or otherwise apply other modifications to the good faith estimate 36. The software application 26 adds the conspicuous notice 60 to indicate the good faith estimate 36 is an unofficial, draft, not-for-disclosure copy.

The conspicuous notice 60, however, may not be added if disclosure is intended. When the user interface 42 prompts the user, the user may respond and indicate that the good faith estimate 36 will be disclosed to the prospective borrower. When the good faith estimate 36 will be disclosed to the prospective borrower, the software application 26 generates the good faith estimate 36 without modification. That is, the software application 26 does not add the conspicuous notice 60 to the electronic copy 52 of the good faith estimate 36. The software application 26 stores the electronic copy 52 of the good faith estimate 36 in the memory 28. Only if the loan officer decides that the good faith estimate 36 is official, and will be disclosed to the prospective borrower, will the good faith estimate 36 be created without the conspicuous notice 60.

Exemplary embodiments may also track the history of fees communicated to the prospective borrower. Exemplary embodiments may make an electronic copy of all the fees and other loan data and store them in a table 70 in the memory 28. The software application 26 may also store an electronic copy of the good faith estimate 36 in any format, such as a .pdf (or Portable Document Format), that allows for retrieval and reprinting. The software application 26 may also store a history 72 of all Disclosed Fees in a historical database 74. The history 72 stores electronic information such as a copy of the fees, a copy of disclosed documents or information to recreate such documents. Exemplary embodiments may also compare Disclosed Fees to current Fees and apply rules. The historical database 74 is illustrated as being remotely located and queried via the server 34 and the communications network 22, but the historical database 74 may be locally stored in the memory 28.

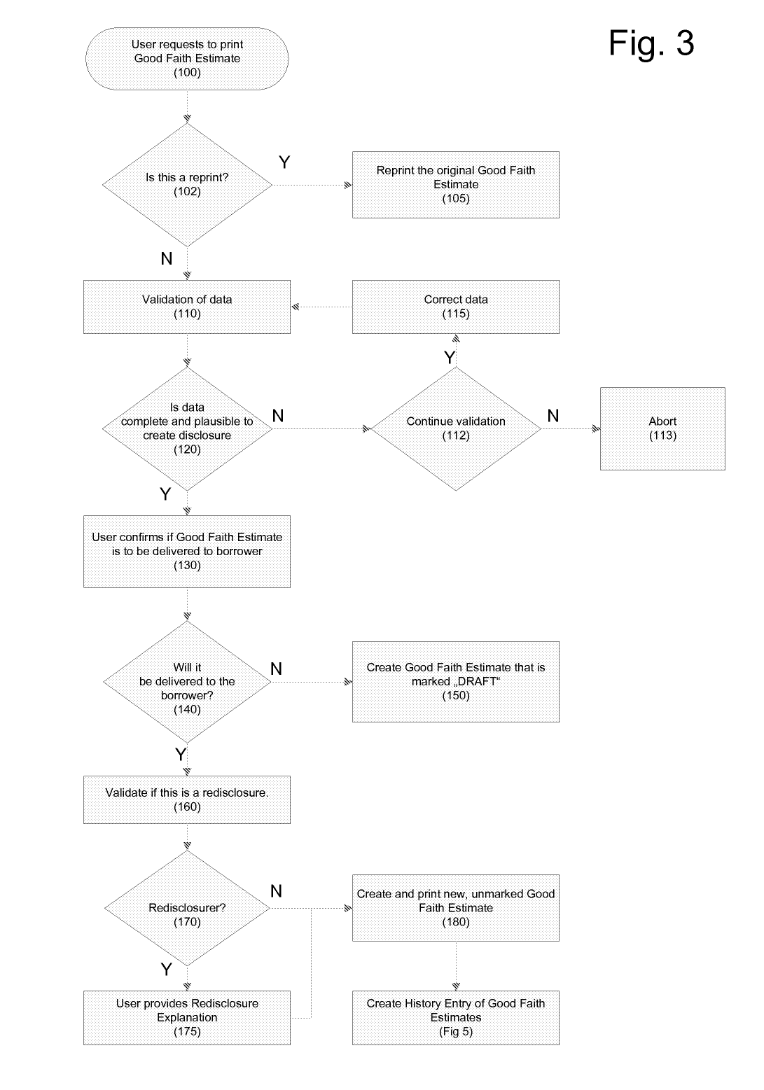

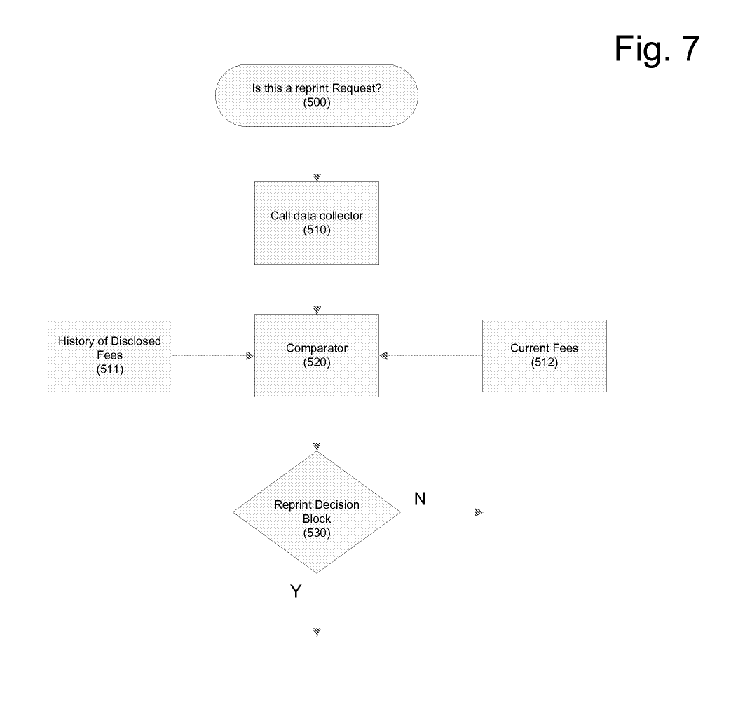

FIGS. 3-5 illustrate a method of providing good faith estimates, according to exemplary embodiments. The user, most often a loan officer, requests to print the good faith estimate 36 (100). The good faith estimate 36 may be based on several variables previously entered and stored in the software application 26, including the Current Fees. The method first determines if the requested print is a reprint (102) (as the paragraphs accompanying FIG. 7 further explain). If the request is a reprint, then the original good faith estimate 36 is reprinted (105). If the request is not a reprint, but creation of a new good faith estimate 36, then a first validation of the data is performed (110). The validation may be performed against predefined rules. The validation takes Current Fees and other data needed into account to perform the validation. If such validation is not passed successfully, the user will have the option to continue the process (112). If the user selects to continue the process the user will have to correct the data (115) and pass corrected data through the validation step (110) again. Alternatively the user may have an option to abort the process (113).

If the data is complete and plausible, the user will be asked if the good faith estimate 36 is to be delivered to the borrower (130). If the user decides that the good faith estimate 36 is not to be delivered to the borrower, then the good faith estimate 36 will be created and conspicuously marked as “DRAFT,” “UNOFFICIAL,” “NOT FOR DISCLOSURE,” or some other notice (150). An electronic watermark, for example, may be applied to an electronic copy of the good faith estimate 36 (as FIG. 2 illustrated). The good faith estimate 36 may include an additional parameter, configuration, setting, or feature that denies printing and/or emailing the good faith estimate 36. The good faith estimate 36 may include other features that only permit display or viewing on the display device 44.

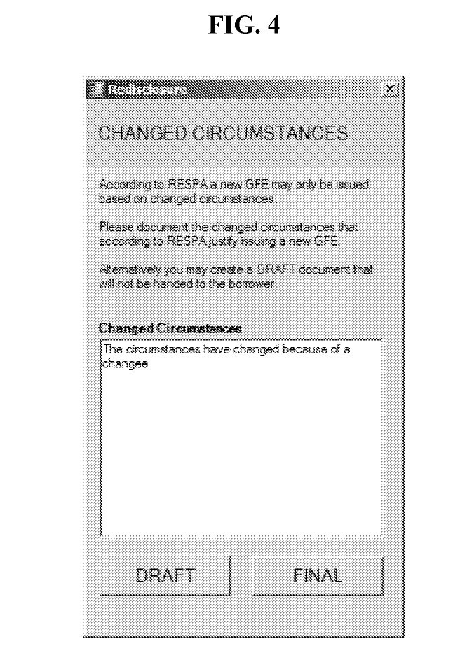

If the user decides to print the good faith estimate 36 for delivery to the prospective borrower (140), exemplary embodiments may perform another, second validation before printing or creating the good faith estimate 36 (Block 160). If the good faith estimate 36 has been previously printed for the same loan and previously handed to the prospective borrower, then the new good faith estimate 36 is considered to redisclose Fees. Block (160) accesses the history 72 of good faith estimates and checks if a good faith estimate 36 has been previously printed and provided to the borrower. If the prospective borrower has been previously provided a good faith estimate, then this latest printing is considered to be a redisclosure (170). (Exemplary embodiments may prevent the user from changing the Current Fees, once a Good Faith Estimate without DRAFT has been issued.) In the case of a redisclosure, the user is required to enter a redisclosure explanation (175) that explains the reason for the redisclosure. FIG. 4, for example, is a screen shot of a dialog box for entry and storage of the redisclosure explanation. In step (180) the method will then print a new, unmarked good faith estimate based on the Current Fees. This good faith estimate 36 will be composed without any watermark or other notice (160) and can be delivered to the borrower.

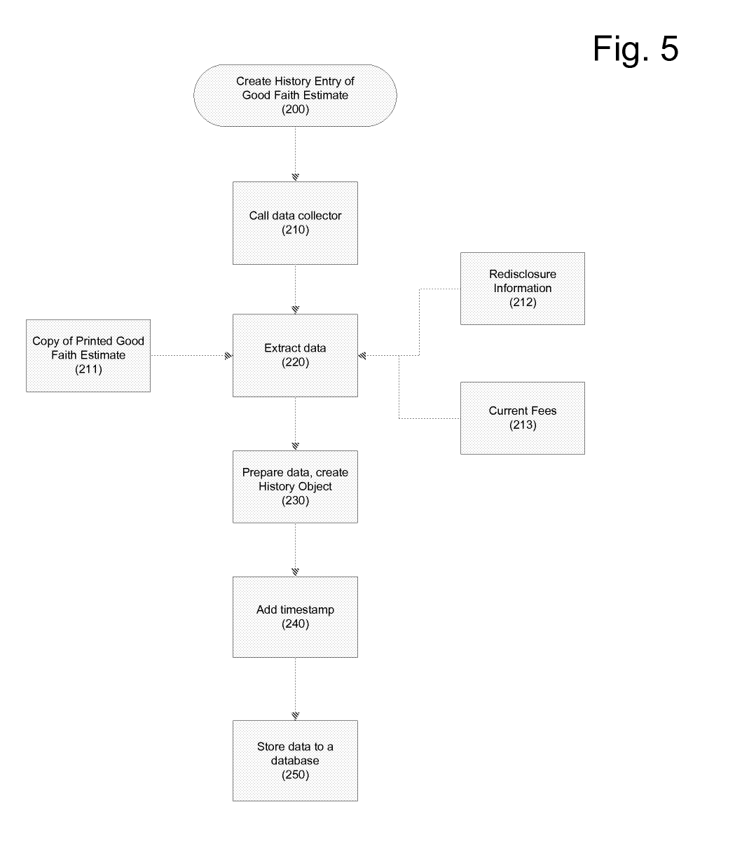

The method continues with FIG. 5. Here exemplary embodiments create a History Entry of Good Faith Estimates and stores the entries in the historical database 74. The first step is the initiation to Create the History of Good Faith Estimate (200). The data collector (210) will access different locations via a web service or other methods to collect objects that contain different data. Such objects can be simple numbers, or more complex XML structures such as a Mismo-compliant XML representations of a loan or proprietary loan objects. The next block (220) will extract the data from these objects. In particular an electronic copy of the printed good faith estimate 36 will be extracted (220). The electronic copy of the good faith estimate 36 may be stored in any format, such as a .pdf (or Portable Document Format), that allows for retrieval and reprinting. If there is redisclosure information (as previously explained and illustrated by block 175 of FIG. 2), then the redisclosure information will be extracted as well (212). In particular, the Current Fees (213) will be extracted. Additional loan information may be extracted as well (not shown in diagram). The data will then be prepared (230) and converted into a storable history object such as a particular XML object. A timestamp (240) will be added to the history object. Also the user who creates it will be referenced in the object before it is stored into a database (250).

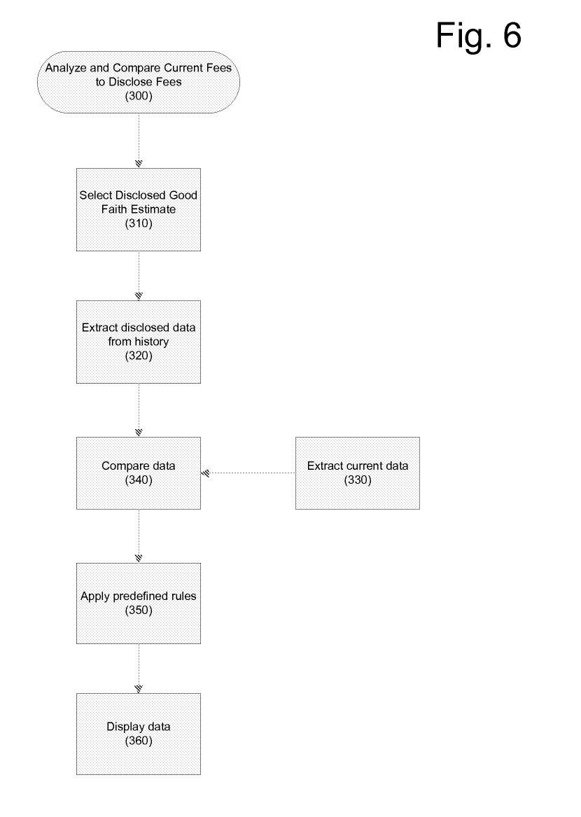

FIG. 6 is a flowchart further illustrating the method of providing good faith estimates, according to exemplary embodiments. Here exemplary embodiments compare Disclosed Fees to Current Fees. In a first step (300) a user makes a request in the user interface 42 to compare Disclosed Fees to Current Fees. Among a possible list of Disclosed Good Faith Estimates the user will select the Good Faith Estimate with the Disclosed Fees that the Current Fees should be compared to (310). Data is then extracted from the history object for that Good Faith Estimate. In this context data consists of Fees and other loan data that has been stored for the history object for that Good Faith Estimate (320). Block (340) collects and compares data from the Good Faith Estimate and also collects current data, including the Current Fees (330). In an next step in block (350) rules are applied to the different Disclosed Fees and the Current Fees. Based on these rules differences and warnings will be created. These rules trigger some workflow event. Finally in block (360) the Disclosed Fees and the Current Fees are displayed including an analysis of the rules that have been applied.

FIG. 7 is a flowchart further illustrating the method of providing good faith estimates, according to exemplary embodiments. The method evaluates if the printing of the good faith estimate 36 constitutes printing a new Good Faith Estimate with changed Fees, or if it is merely a reprint based on Disclosed Fees. FIG. 7 illustrates this determination. Upon the request (500) a data collector is called that provides the History of Disclosed Fees (511) and Current Fees (512) to the Comparator (520). The Comparator will then compare the History of Disclosed Fees to the Current Fees and based on rules will decide if the Current Fees are within an acceptable range of the Disclosed Fees. If this is the case, then the Decision Block (530) will return Yes, else No. The output of the decision block 530 may be visually and/or audibly displayed by the software application 26 on the display device 44.

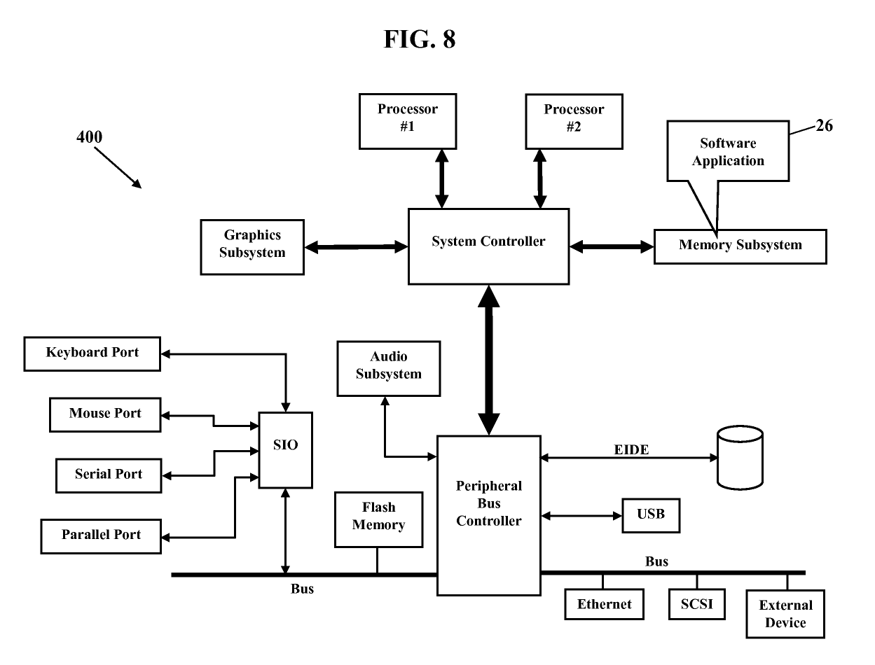

FIG. 8 is a schematic illustrating still more exemplary embodiments. FIG. 8 is a detailed block diagram illustrating the software application 26 operating within the processor-controlled device 20. The software application 26 may be stored in a memory subsystem of the processor-controlled device 20. One or more processors communicate with the memory subsystem and execute the software application 26. Because the architecture and operating principles of the processor-controlled device 20 is well known, the hardware and software componentry are not further shown and described. If, however, the reader desires more details, the reader is invited to consult the following sources: WILLIAM STALLINGS, COMPUTER ORGANIZATION AND ARCHITECTURE: DESIGNING FOR PERFORMANCE (7th Ed., 2005); DAVID A. PATTERSON & JOHN L. HENNESSY, COMPUTER ORGANIZATION AND DESIGN: THE HARDWARE/SOFTWARE INTERFACE (3rd. Edition 2004); LAWRENCE HARTE et al., GSM SUPERPHONES (1999); SIEGMUND REDL et al., GSM AND PERSONAL COMMUNICATIONS HANDBOOK (1998); JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004). Any such implementation in processor-controlled devices does not need to be implemented on one single location or one single processor. Distributed computing and service oriented architecture enables different blocks or sub-blocks to be executed at any location.

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. These types of computer-readable media, and other types not mention here but considered within the scope of the exemplary embodiments. A computer program product comprises processor-executable instructions for generating good faith estimates.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for providing good faith estimates, comprising:
receiving a selection in a user interface to print a good faith estimate for a mortgage application;
prompting a user whether the good faith estimate will be provided to a prospective borrower;
generating the good faith estimate;
storing an electronic copy of the good faith estimate in memory when the user indicates the good faith estimate is provided to the prospective borrower;
modifying the electronic copy of the good faith estimate when the user indicates the good faith estimate will not be provided to the prospective borrower; and
storing the modified electronic copy of the good faith estimate in the memory.

2. The method according to claim 1, further comprising adding an electronic watermark to the electronic copy to indicate the good faith estimate is not for disclosure to the prospective borrower.

3. The method according to claim 1, further comprising adding text to the electronic copy to indicate the good faith estimate is not for disclosure to the prospective borrower.

4. The method according to claim 1, further comprising adding a conspicuous notice to the electronic copy to indicate the good faith estimate is not for disclosure to the prospective borrower.

5. The method according to claim 1, further comprising assigning a date and time stamp of generation to the good faith estimate.

6. The method according to claim 5, further comprising logging the date and time stamp in the memory and associating the date and time stamp to the good faith estimate.

7. The method according to claim 1, further comprising validating fees associated with the good faith estimate.

8. The method according to claim 1, further comprising comparing fees associated with the good faith estimate to a set of rules.

9. The method according to claim 1, further comprising storing fees associated with the good faith estimate when the user indicates the good faith estimate will be provided to the prospective borrower.

10. The method according to claim 1, further comprising storing a history of print requests for the good faith estimate.

11. The method according to claim 10, further comprising determining whether the good faith estimate has been previously printed.

12. The method according to claim 10, further comprising requiring an explanation from the prospective borrower when the good faith estimate has been previously printed.

13. A system, comprising:
a processor executing code stored in memory that causes the processor to:
receive a selection in a user interface to print a good faith estimate for a mortgage application;
prompt a user whether the good faith estimate will be provided to a prospective borrower;
generate the good faith estimate;
store an electronic copy of the good faith estimate in memory when the user indicates the good faith estimate is provided to the prospective borrower;
modify the electronic copy of the good faith estimate when the user indicates the good faith estimate will not be provided to the prospective borrower; and
store the modified electronic copy of the good faith estimate in the memory.

14. The system according to claim 13, further comprising code that causes the processor to add an electronic watermark to the electronic copy to indicate the good faith estimate is not for disclosure to the prospective borrower.

15. The system according to claim 13, further comprising code that causes the processor to add text to the electronic copy to indicate the good faith estimate is not for disclosure to the prospective borrower.

16. The system according to claim 13, further comprising code that causes the processor to add a conspicuous notice to the electronic copy to indicate the good faith estimate is not for disclosure to the prospective borrower.

17. A computer readable medium storing processor executable code for performing a method, the method comprising:
receiving a selection in a user interface to print a good faith estimate for a mortgage application;
prompting a user whether the good faith estimate will be provided to a prospective borrower;
generating the good faith estimate;
storing an electronic copy of the good faith estimate in memory when the user indicates the good faith estimate is provided to the prospective borrower;
modifying the electronic copy of the good faith estimate when the user indicates the good faith estimate will not be provided to the prospective borrower; and
storing the modified electronic copy of the good faith estimate in the memory.

18. The computer readable medium according to claim 17, further comprising code for adding an electronic watermark to the electronic copy to indicate the good faith estimate is not for disclosure to the prospective borrower.

19. The computer readable medium according to claim 17, further comprising code for adding text to the electronic copy to indicate the good faith estimate is not for disclosure to the prospective borrower.

20. The computer readable medium according to claim 17, further comprising code for adding a conspicuous notice to the electronic copy to indicate the good faith estimate is not for disclosure to the prospective borrower.
